(19) United States
(12) Patent Application Publication
(10) Pub. No.: US 2013/0116381 A1
(43) Pub. Date: May 9, 2013

(54) Process For Making Polysiloxane Emulsions

(71) Applicants: Mark Keinath, Saginaw, MI (US); Yihan Liu, Midland, MI (US); Jeffery Rastello, Saginaw, MI (US); Andreas Stammer, Pont-A-Celles (BE)

(72) Inventors: Mark Keinath, Saginaw, MI (US); Yihan Liu, Midland, MI (US); Jeffery Rastello, Saginaw, MI (US); Andreas Stammer, Pont-A-Celles (BE)

(73) Assignee: DOW CORNING CORPORATION, MIDLAND, MI (US)

(21) Appl. No.: 13/811,310

(22) PCT Filed: Jul. 20, 2011
(86) PCT No.: PCT/US2011/044679

§ 371 Date: Jan. 21, 2013

Related U.S. Application Data
(60) Provisional application No. 61/366,547, filed on Jul. 22, 2010.

(51) Int. Cl. C08L 83/04

(52) U.S. Cl. CPC C08L 83/04
USPC 524/860

(57) ABSTRACT

A process is described for making polysiloxane emulsions by emulsion polymerizing a silicon monomer or oligomer under an elevated pressure. The process produces emulsions of a polysiloxane containing a lower amount of octamethylcyclotetrasiloxane (D4) and decamethylcyclopentasiloxane (D5) than conventional emulsion polymerization techniques. The emulsions by the inventive method can be used in cosmetic and personal care products, for textile treatment, lubrication, release, and building material protections.

### CROSS-REFERENCE TO RELATED APPLICATIONS

This application claims the benefit of U.S. Application No. 61/366,547 as filed on 22 Jul. 2010.

### BACKGROUND OF THE INVENTION

Aqueous emulsions of silicones are used widely in various applications. One method of preparing such emulsions is by emulsion polymerization, such as representatively described in: U.S. Pat. No. 2,891,920 to Hyde et al, U.S. Pat. No. 3,294,725 to Findlay et al., and U.S. Pat. No. 6,316,541 to Gee. Aqueous emulsions of silicone resins may be prepared by using siloxane monomers containing all or a substantial amount of trifunctional units of the formula RSiO_{3/2} (T unit) such as representatively described in; U.S. Pat. No. 3,433,780 to Cekada, U.S. Pat. No. 4,778,624 to Ohashi, et.al. U.S. Pat. No. 4,935,464 to Ona, U.S. Pat. No. 4,424,297 to Bey, U.S. Pat. No. 5,281,657 to Mautner et al, U.S. Pat. No. 4,857,582 to Wolfgruber et al., U.S. Pat. No. 6,245,852 to Hasegawa, or EP1765911 to Gee & Liu.

Reducing the presence of solvents, un-reacted siloxanes, catalyst residues, cyclic polymerization byproducts, and other impurities in silicone emulsions is an ongoing challenge in the art. The need to reduce such impurities may arise, among other reasons, when the presence of impurities is incompatible with downstream applications (for example, medical, cosmetic, and personal care applications), where the presence of impurities would reduce the stability of an emulsion, or where regulatory requirements require removal or reduction of their presence. In particular, there is an interest to reduce the presence of cyclosiloxanes, such as octamethylcyclotetrasiloxanes and decamethylcyclopentasiloxanes, in silicone emulsions.

When linear polyorganosiloxanes are prepared from cyclic organosiloxanes by equilibrating ring-opening polymerization using an anionic or cationic catalysts, the polymerization reaction leads to an equilibrium mixture of linear polysiloxanes and ca. 15-18 wt % cyclic siloxanes, among which octamethylcyclotetrasiloxanes and decamethylcyclopentasiloxanes are most predominate. Polymerization in an emulsion, i.e., emulsion polymerization, yields the same typical equilibrium concentration of the cyclic siloxanes in the final polysiloxane.

When the present inventors conducted siloxane emulsion polymerizations under elevated pressures, it was surprisingly found that the polysiloxane composition produced contained a significantly lower level of cyclic siloxanes than otherwise would be produced under the atmospheric pressure. Polysiloxanes containing no or a low level of volatile cyclics may be desirable for certain applications.

### BRIEF SUMMARY OF THE INVENTION

The present invention relates to a process for making polysiloxane emulsions by emulsion polymerizing a silicon monomer or oligomer under an elevated pressure to form an emulsion of a polysiloxane containing a lower amount of octamethylcyclotetrasiloxanes and decamethylcyclopentasiloxanes than conventional emulsion polymerization techniques. The emulsions by the inventive method can be used in cosmetic and personal care products, for textile treatment, lubrication, release, and building material protections.

The present invention provides a process for producing a polysiloxane emulsion comprising the steps of:
I) combining;
   a) an emulsifier,
   b) a silicon monomer or oligomer having a solubility in water of at least 10 parts per billion (0.01 mg/L),
   c) a polymerization catalyst,
      and water to form a mixture,
II) reacting the mixture of step I) in a closed system having a pressure greater than 1 MPa to form a polysiloxane emulsion.

### DETAILED DESCRIPTION OF THE INVENTION

The first step in the process of the present invention is combining;
a) an emulsifier,
b) a silicon monomer or oligomer having a solubility in water of at least 10 parts per billion (0.01 mg/L),
c) a polymerization catalyst,
   and water to form a mixture.

### The Emulsifier

As used herein, “emulsifier” refers to any compound or substance that enables the formation of an emulsion. The emulsifier may be selected from any surface active compound or polymer capable of stabilizing emulsions. Typically, such surface active compounds or polymers stabilize emulsions by preventing coalescence of the dispersed particles. The surface active compounds useful as emulsifiers in the present process may be a surfactant or combination of surfactants. In principle, the surfactant used can be any surfactant known for emulsification of silicones and can be cationic, anionic, nonionic, and/or amphoteric. Mixtures of surfactants of different types and/or different surfactants of the same type can be used. Where more than one surfactant is used, the surfactants can be premixed, added simultaneously, or can be added successively to form the mixture in step I).

Some suitable anionic surfactants which can be used include (i) sulfonic acids and their salts, including alkyl, alkylaryl, alkylnapthalene, and alkyldiphenylether sulfonic acids, and their salts, having at least 6 carbon atoms in the alkyl substituent, such as dodecylbenzensulfonic acid, and its sodium salt or its amine salt; (ii) alkyl sulfates having at least 6 carbon atoms in the alkyl substituent, such as sodium lauryl sulfate; (iii) the sulfate esters of polyoxyethylene monoalkyl ethers; (iv) long chain carboxylic acid surfactants and their salts, such as lauric acid, steric acid, oleic acid, and their alkali metal and amine salts.

It should be noted that certain anionic surfactants such as dodecylbenzene sulfonic acid, are capable of functioning both as a surfactant and a catalyst; in which case, the need for an additional acid catalyst, may or may not be needed. The use of a combination of an anionic surfactant and a strong acid catalyst such as sulfuric acid is also a viable option. Anionic surfactants that are commercially available include dodecylbenzenesulfonic acid sold under the names Bio-Soft S-100 or Bio-Soft S-101, and its triethanolamine salt sold under the name Bio-Soft N-300 by the Stepan Company, Northfield, Ill.

Some suitable cationic surfactants which can be used include (i) fatty acid amines and amides and their salts and derivatives, such as aliphatic fatty amines and their derivatives; and (ii) quaternary ammonium compounds such as alkyl trimethylammonium and dialkyldimethylammonium halides, or acetates, or hydroxides, having at least 8 carbon atoms in each alkyl substituent. Cationic surfactants that are commercially available include compositions sold under the names Arquad T27 W, Arquad 16-29, by Akzo Nobel Chemicals Inc., Chicago, Ill.; and Ammonyx Cetac-30 by the Stepan Company, Northfield, Ill.

The amount of anionic surfactant and cationic surfactant can be 0-50 percent by weight based on the weight of the polysiloxane to be formed. The exact amount will necessarily depend on the particular particle size of the polysiloxane in the emulsion being targeted. Typically, less than 20 percent by weight, based on the weight of the polysiloxane to be formed, of the active anionic surfactant or the cationic surfactant, can be used to produce emulsions containing polysiloxane particles having an average particle size greater than 50 nanometer (0.1 micrometer μm).

The nonionic surfactants preferred for use according to the invention have a hydrophilic-lipophilic balance (HLB) between 10-20. While nonionic surfactants with an HLB of less than 10 can be used, a hazy solution is likely to result, due to the limited solubility of the nonionic surfactant in water, with the result that an effective surfactant effect does not occur. It is preferred therefore, that when using a nonionic surfactant with an HLB of less than 10, that another nonionic surfactant with an HLB of greater than 10 be added, so that the combined HLB of the two surfactants is greater than 10.

Some suitable nonionic surfactants which can be used include polyoxyethylene alkyl ethers, polyoxyethylene alkyl phenyl ethers, polyoxyethylene fatty acid esters, sorbitan fatty acid esters, and polyoxyethylene sorbitan fatty acid esters. Nonionic surfactants which are commercially available include compositions such as (i) 2,6,8-trimethyl-4-nonyl polyoxyethylene ether sold under the names Tergitol TMN-6 and Tergitol TMN-10; (ii) the

C11-15 secondary alkyl polyoxyethylene ethers sold under the names Tergitol 15-S-7, Tergitol 15-S-9, Tergitol 15-5-15, Tergitol 15-5-30, and Tergitol 15-5-40, by the Dow Chemical Company, Midland, Mich.; octylphenyl polyoxyethylene (40) ether sold under the name Triton X405 by the Dow Chemical Company, Midland, Mich.; (iii) nonylphenyl polyoxyethylene (10) ether sold under the name Makon 10 by the Stepan Company, Northfield, Ill.; (iv) ethoxylated alcohols sold under the name Trycol 5953 by Henkel Corp./Emery Group, Cincinnati, Ohio; and (v) ethoxylated alcohols sold under the name Brij L23 by Croda Inc. Edison, N.J.

The nonionic surfactant may also be a silicone polyether (SPE). The silicone polyether may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure.

### The Silicon Monomer or Oligomer

Component b) is a silicon monomer or oligomer having a solubility in water of at least 10 parts per billion (0.01 mg/L). The silicon monomer or oligomer may be selected from a cyclic siloxane containing three to six silicon atoms, or a mixture thereof, or a hydrolytic product thereof. Some representative cyclic siloxanes are hexamethylcyclotrisiloxane, a solid at room temperature, with a boiling point of 134° C. and formula (Me₂SiO)₃; octamethylcyclotetrasiloxane (D₄) with a boiling point of 176° C., viscosity of 2.3 mm²/s, and formula (Me₂SiO)₄; decamethylcyclopentasiloxane with a boiling point of 210° C., viscosity of 3.87 mm²/s, and formula (Me₂SiO)₅; and dodecamethylcyclohexasiloxane with a boiling point of 245° C., viscosity of 6.62 mm²/s, and formula (Me₂SiO)₆. It is possible to use other types of cyclic siloxanes such as cyclic siloxanes containing saturated alkyl groups with 2-30 carbon atoms, or cyclic siloxanes in which Si-vinyl groups are used in place of one or more of the Si—Me groups present.

The silicon monomer or oligomer may also contain one or more organosilanes of the general formula RₐSi(OR′)₄₋ₐ where R are the same or different monovalent hydrocarbon or organofunctional substituted hydrocarbon groups having 1-18 carbon atoms, R′ are selected from the group consisting of the hydrogen atom, alkyl radicals containing 1 to 4 carbon atoms, CH₃C(O)—, CH₃CH₂C(O)—, HOCH₂CH₂—, CH₃OCH₂CH₂—, and C₂H₅OCH₂CH₂—, a is 0, 1, 2 or 3, or a hydrolytic product thereof.

The organosilane may be a single alkylalkoxysilane or a mixture of alkylalkoxysilanes. Some suitable alkoxysilanes are methyltrimethoxysilane, methyltriethoxysilane, methyltripropoxysilane, ethyltrimethoxysilane, ethyltributoxysilane, propyltrimethoxysilane, propyltriethoxysilane, isobutyltrimethoxysilane, isobutyltriethoxysilane, butyltrimethoxysilane, butyltriethoxysilane, hexyltrimethoxysilane, n-octyltriethoxysilane, n-octyltrimethoxysilane, i-octyltrimethoxysilane, i-octyltriethoxysilane, dimethyldimethoxysilane, dimethyldiethoxysilane, diethyldimethoxysilane, diisobutyldimethoxysilane, dibutyldiethoxysilane, dihexyldimethoxysilane. Such alkylalkoxysilanes are known and are commercially available. Representative examples are described in U.S. Pat. No. 5,300,327 (Apr. 5, 1994), U.S. Pat. No. 5,695,551 (Dec. 9, 1997), and U.S. Pat. No. 5,919,296 (Jul. 6, 1999).

### The Polymerization Catalyst

The polymerization reaction is carried out in an aqueous medium containing the surfactant, and it is typically catalyzed with a siloxane condensation catalyst. Condensation polymerization catalysts which can be used include (i) strong acids, such as substituted benzenesulfonic acids, aliphatic sulfonic acids, hydrochloric acid, and sulfuric acid; and (ii) strong bases such as quaternary ammonium hydroxides, and alkali metal hydroxides. Some ionic surfactants, such as dodecylbenzenesulfonic acid, can additionally function as a catalyst. Other examples of suitable catalysts can be found in U.S. Pat. Nos. 2,891,920; 3,294,725; 4,999,398; 5,502,105; 5,661,215; and 6,316,541.

Typically, though not limited to, an acid catalyst is used to catalyze polymerization in an anionic stabilized emulsion; whereas and a basic catalyst is used to catalyze polymerization in a cationic stabilized emulsion. For nonionically stabilized emulsions, polymerization can be catalyzed by using either an acid catalyst or a basic catalyst. The amount of the catalyst present in the aqueous reaction medium should be at levels of 1×10⁻³ to 1 molarity (M).

Other optional components may be added in step I), provided they do not inhibit or deter the subsequent reaction of the silicon monomer or oligomer that occurs in step II of the process. Such optional components include foam control agents, anti-freeze agents, and biocides.

The amounts of components a), b), c), any additional optional components, and water used to prepare the mixture in step I) may vary. Typically, the weight percent amounts of each in the mixture of step I) may ranges as follows:
a) the emulsifier from 0 to 40 wt %, alternatively from 0.1 to 25 wt % alternatively from 0.5 to 20 wt %;
b) the silicon monomer or oligomer from 1 to 80 wt %, alternatively from 5 to 50 wt %, alternatively from 10 to 40 wt %;
c) the polymerization catalyst from 0.01 to 20 wt %, alternatively from 0.01 to 10 wt %, alternatively from 0.01 to 5 wt %;
   where the amounts of a), b), c), any optional components, and water sums to 100 wt %.

Once components a), b), c) and water are combined, the resulting mixture may be used directly in step II) or alternatively may be subjected to further mixing. Further mixing may be accomplished with simple stirring techniques. Alternatively, further mixing may be accomplished using various shear mixing techniques, such as that provided by a homogenizer or sonolator.

In one embodiment, the mixture formed in step I) may be an emulsion. Thus, components a), b), c) and water are combined and mixed with sufficient shear force to form an aqueous continuous emulsion having the silicon monomer or oligomer as part of the dispersed oil phase. The mixing may occur either as a batch, semi-continuous, or continuous process. The mixing may be effected by shear mixing techniques such as provided by a homogenizer, sonolator. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, corotating extruders, such as those manufactured by Krupp Werner & Pfleiderer Corp (Ramsey, N.J.), and Leistritz (NJ); twin-screw counter-rotating extruders, two-stage extruders, twin-rotor continuous mixers, dynamic or static mixers or combinations of these equipments.

The second step in the present process involves reacting the mixture of step I) in a closed system having a pressure greater than 1 MPa to form a polysiloxane emulsion. As used herein “reacting” means effecting an emulsion polymerization reaction of the mixture resulting from step I). Any known techniques for effecting emulsion polymerization of silicon monomer or oligomers may be used in step II) of the present process. As used herein, the term emulsion polymerization refers to its accepted meaning in the art, for example, any of the polymerization processes represented by processes described in U.S. patents U.S. Pat. No. 2,891,920 (Jun. 23, 1959), U.S. Pat. No. 3,294,725 (Dec. 27, 1966), U.S. Pat. No. 4,999,398 (Mar. 12, 1991), U.S. Pat. No. 5,502,105 (Mar. 26, 1996), U.S. Pat. No. 5,661,215 (Aug. 26, 1997), and U.S. Pat. No. 6,316,541 (Nov. 13, 2001), which are incorporated herein by reference, for their teaching of processing conditions to effect emulsion polymerization.

The inventors found that reacting the mixture of step I) via an emulsion polymerization process conducted in a closed system having a pressure greater than 1 MPa (1,000,000 Pascals), alternatively greater than 2 MPa, alternatively greater than 3 MPa, alternatively greater than 4 MPa, resulted in a significant but unexpected lower level of cyclic siloxanes than otherwise would be produced under the atmospheric pressure. In the view of the inventors, this is completely unexpected because the reaction takes places solely in the liquid phase and as such the effect of pressure on such a process would have been expected to be negligible because both the reactants and the products are liquids and the change in volume is not so significant as to lead to an expectation of a significant decrease in volume of the products compared to the reactants.

The emulsion polymerization reaction in step II) may proceed in any equipment suitable for providing mixing of the components at pressures above 1 MPa. The mixing may occur either as a batch, semi-continuous, or continuous process. Mixing may occur, for example using, batch mixing equipment with medium/low shear capability. Included as laboratory sized examples, but not limited to, are a (i) Parr® Bench Top Reactor as supplied by Parr Instrument Company of Moline, Ill.; or an (ii) LC series Bench Stand Model as supplied by Pressure Products Industries, Milton Roy of Warminster, Pa.; or a (iii) BR series High Pressure Reaction Vessel as supplied by Berghof of Eningen, Germany; or (iv) several models available from Autoclave Engineers of Erie, Pa. Many of these suppliers also offer custom solutions for designing and building a production scale version of their lab scale models. Other custom solution suppliers for large scale production would be (i) Zeyon of Erie, Pa.; (ii) Pressure Chemical Company of Pittsburgh, Pa.; (iii) Pfaudler of Rochester, N.Y.; and (iv) High Pressure Autoclave Reactors from Ernst Haage of Germany.

The emulsion polymerization reaction of step II) typically proceeds while simultaneously mixing and heating the mixture or emulsion composition resulting from step I). Emulsion polymerization processes of the present invention are typically carried out at a temperature in the range of 25-100° C., or alternatively in the range of 50-95° C.

Typically most silicone emulsion polymerizations involve a ring opening of a cyclic siloxane oligomer using an acid or a base catalyst in the presence of water. Upon opening of the ring, siloxanes with terminal hydroxy groups are formed. These siloxanes then react with one another by a condensation reaction to form the siloxane polymer. A simplified representation of the process chemistry is shown below for a volatile siloxane oligomer such as octamethylcyclotetrasiloxane, in which Me represents CH₃; (Me₂SiO)₄+H₂O+Catalyst→HOMe₂SiOMe₂SiOMe₂SiOSiMe₂OH→HOMe₂SiOMe₂SiOMe₂SiOSiMe₂OH +HOMe₂SiOMe₂SiOMe₂SiOSiMe₂OH→HOMe₂SiO(Me₂SiO)₆SiMe₂OH+H₂O.

The emulsion polymerization reaction effected in step II) can be stopped at the desired level of conversion of silicon monomer or oligomer to a polysiloxane and/or particle size by using methods known in the art. Reaction times of less than 24 hours, and typically less than 5 hours, are sufficient to achieve the desired particle size and/or level of conversion. The methods for stopping the reaction typically encompass neutralization of the catalyst by the addition of equal or slightly greater stoichiometric amount of acid or base (depending upon the type of catalyst). Either a strong or weak acid/base may be used to neutralize the reaction. Care must be taken when using a strong acid/base not to over neutralize as it may be possible to re-catalyze the reaction. It is typical to neutralize with sufficient quantities of acid or base such that the resulting emulsion has a pH of less than 7 when a cationic surfactant is present and a pH of greater than 7 when an anionic surfactant is present.

The present invention also relates to the emulsions produced by the present methods. In one embodiment, the emulsions produced by the present process have an octamethylcyclotetrasiloxane and decamethylcyclopentasiloxane content that is less than 10 weight percent, alternatively less than 5 weight percent, alternatively less than 3 weight percent, of the total silicone content of the emulsion. The D₄ and D₅ cyclic siloxane content (that is, the combined amounts of octamethylcyclotetrasiloxanes (D₄) and decamethylcyclopentasiloxanes (D₅)) may be determined by harvesting the polysiloxane phase of the emulsion with a mixture of polar and nonpolar organic solvents. The solvents containing any cyclic siloxanes can then be analyzed using common gas chromatography techniques.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

### Comparative Example

This example illustrates using a conventional process to produce an emulsion of polysiloxane by emulsion polymerizing a cyclic siloxane at atmospheric pressure.

De-ionized water (335.4 grams), Biosoft® S-101 (dodecylbenzenesulfonic acid) from Stepan (56.4 grams), Brij® 35L (polyoxyethylene lauryl ether, 72% active in water) from Croda (24.0 grams), and Dow Corning® 244 fluid (cyclic dimethylsiloxane having an average of 4 Si atoms per molecule) (150.0 grams) were added to a Parr@ Bench Top Reactor (Model # 4520) equipped with a stirring shaft fit with two sets of blades. The contents were mixed at a constant speed of 300 rpm throughout the experiment. The contents were heated to and held at 70° C. for 5.5 hours after which it was cooled to 22° C. and held for another 70 minutes before triethanolamine (34.2 grams, 85% active in water) was added to neutralize the reaction. The resulting product was an emulsion with a mono-modal particle size distribution having a volume average particle diameter of 37.5 nanometers. The emulsion contained 2.5% octamethylcyclotetrasilane, 1.7% decamethylcylcopentasiloxane, and 0.57% dodecamethylcylcohexasiloxane, as measured by gas chromotography.

### Example 1

De-ionized water (335.4 grams), Biosoft® S-101 (dodecylbenzenesulfonic acid) from Stepan (56.4 grams), Brij® 35L (polyoxyethylene lauryl ether, 72% active in water) from Croda (24.0 grams), and Dow Corning® 244 fluid (cyclic dimethylsiloxane having an average of 4 Si atoms per molecule) (150.0 grams) were added to a Parr@ Bench Top Reactor (Model # 4520) equipped with a stirring shaft fit with two sets of blades. The contents were mixed at a constant speed of 300 rpm throughout the experiment. The reactor was pressurized to 150 psi (1.03 MPa) using compressed nitrogen gas, and then heated to 70° C. This resulted in an increase in the pressure to 174 psi (1.20 MPa). The contents were held at this condition for 5.5 hours, and was then cooled to 22° C. and held for another 70 minutes. The reaction was neutralized with triethanolamine (34.2 grams, 85% active in water) while at a pressure of 150 psi using a Teledyne ISCO Syringe pump (model # 500D) at a rate of 17.1 ml/min. The contents were mixed for 15 minutes and the vessel was depressurized to atmosphere. The resulting product was an emulsion with a mono-modal particle size distribution having a volume average particle diameter of 43.0 nanometers. The emulsion contained 1.8% octamethylcyclotetrasilane, 1.3% decamethylcylcopentasiloxane, and 0.44% dodecamethylcylcohexasiloxane, as measured by gas chromatography.

### Example 2

De-ionized water (335.4 grams), Biosoft® S-101 (56.4 grams), Brij® 35L (24.0 grams), and Dow Corning® 244 fluid (150.0 grams) were added to the Parr® reactor of Example 1. The contents were mixed at a constant speed of 300 rpm throughout the experiment. The reactor was pressurized to 498 psi (3.43 MPa)using compressed nitrogen gas, and then heated to 70° C. This resulted in an increase in the pressure to 580 psi (4.00 MPa). The contents were held at this condition for 5.5 hours, and was then cooled to 22° C. and held for another 70 minutes. The reaction was neutralized with triethanolamine (34.2 grams, 85% active in water) while at a pressure of 498 psi using the Teledyne syringe pump at a rate of 17.1 ml/min. The contents were mixed for 15 minutes and the vessel was depressurized to atmosphere. The resulting product was an emulsion with a mono-modal particle size distribution having a volume average particle diameter of 35.0 nanometers. The emulsion contained 1.2% octamethylcyclotetrasilane, 0.89% decamethylcylcopentasiloxane, and 0.28% dodecamethylcyclohexasiloxane, as measured by gas chromatography.

### Example 3

De-ionized water (335.4 grams), Biosoft® S-101 (56.4 grams), Brij® 35L (24.0 grams), and Dow Corning® 244 fluid (150.0 grams) were added to the Parr® reactor of Example 1. The contents were mixed at a constant speed of 300 rpm throughout the experiment. The reactor was pressurized to 725 psi (5.00 MPa) using compressed nitrogen gas, and then heated to 70° C. This resulted in an increase in the pressure to 840 psi (5.79 MPa). The contents were held at this condition for 5.5 hours, and was then cooled to 22° C. and held for another 70 minutes. The reaction was neutralized with triethanolamine (34.2 grams, 85% active in water) while at a pressure of 725 psi using the Teledyne syringe pump at a rate of 17.1 ml/min. The contents were mixed for 15 minutes and the vessel was depressurized to atmosphere. The resulting product was an emulsion with a mono-modal particle size distribution having a volume average particle diameter of 30.7 nanometers. The emulsion contained 1.8% octamethylcyclotetrasilane, 1.3% decamethylcylcopentasiloxane, and 0.44% dodecamethylcyclohexasiloxane, as measured by gas chromatography.

### Example 4

De-ionized water (335.4 grams), Biosoft® S-101 (56.4 grams), and Brij® 35L (24.0 grams) were added to the Parr® reactor of Example 1. The contents were mixed at a constant speed of 350 rpm throughout the experiment. The reactor was pressurized to 600 psi using compressed nitrogen gas, and then heated to 70° C. This resulted in an increase in the pressure to 705 psi (4.86 MPa). Dow Corning® 244 fluid (150.0 grams) was added at a rate of 2.632 ml/min using the Teledyne syringe pump followed by de-ionized water (10 grams) at a rate of 2.5 g/min also using the syringe pump. The resultant pressure after these additions was 750 psi (5.17 MPa). The contents were held at this condition for 4.5 hours, and was then cooled to 22° C. and held for another 70 minutes. The reaction was neutralized with triethanolamine (34.2 grams, 85% active in water) while at the elevated pressure using the same syringe pump at a rate of 17.1 ml/min. The contents were mixed for 15 minutes and the vessel was depressurized to atmosphere. The resulting product was an emulsion with a mono-modal particle size distribution having a volume average particle diameter of 34.3 nanometers. The emulsion contained 1.5% octamethylcyclotetrasilane, 1.0% decamethylcylcopentasiloxane, and 0.35% dodecamethylcylcohexasiloxane, as measured by gas chromatography.

### Example 5

De-ionized water (335.4 grams), Biosoft® S-101 (56.4 grams), Brij® 35L (24.0 grams), and Dow Corning® 244 fluid (150.0 grams) were added to the Parr® reactor of Example 1. The contents were mixed at a constant speed of 300 rpm throughout the experiment. The reactor was pressurized to 350 psi (2.41 MPa) using compressed nitrogen gas, and then heated to 70° C. This resulted in an increase in the pressure to 405 psi (2.79 MPa). The contents were held at this condition for 5.5 hours, and was then cooled to 22° C. and held for another 70 minutes. The reaction was neutralized with triethanolamine (34.2 grams, 85% active in water) while at a pressure of 350 psi using the Teledyne syringe pump at a rate of 17.1 ml/min. The contents were mixed for 15 minutes and the vessel was depressurized to atmosphere. The resulting product was an emulsion with a mono-modal particle size distribution having a volume average particle diameter of 36.2 nanometers. The emulsion contained 1.6% octamethylcyclotetrasilane, 1.1% decamethylcylcopentasiloxane, and 0.40% dodecamethylcylcohexasiloxane, as measured by gas chromatography.

### Example 6

De-ionized water (335.4 grams), Biosoft® S-101 (56.4 grams), Brij® 35L (24.0 grams), and Dow Corning® 244 fluid (150.0 grams) were added to the Parr® reactor of Example 1. The contents were mixed at a constant speed of 300 rpm throughout the experiment. The reactor was pressurized to 571 psi (3.94 MPa) using compressed nitrogen gas, and then heated to 70° C. This resulted in an increase in the pressure to 664 psi (4.58 MPa). The contents were held at this condition for 5.5 hours, and was then cooled to 22° C. and held for another 70 minutes. The reaction was neutralized with triethanolamine (34.2 grams, 85% active in water) while at a pressure of 571 psi using the Teledyne syringe at a rate of 17.1 ml/min. The contents were mixed for 15 minutes and the vessel was depressurized to atmosphere. The resulting product was an emulsion with a mono-modal particle size distribution having a volume average particle diameter of 31.5 nanometers. The emulsion contained 1.6% octamethylcyclotetrasilane, 1.1% decamethylcylcopentasiloxane, and 0.37% dodecamethylcylcohexasiloxane, as measured by gas chromatography.

### Example 7

De-ionized water (335.4 grams), Biosoft® S-101 (56.4 grams), Brij® 35L (24.0 grams), and Dow Corning® 244 fluid (150.0 grams) were added to the Parr® reactor of Example 1. The contents were mixed at a constant speed of 300 rpm throughout the experiment. The reactor was pressurized to 421 psi (2.90 MPa) using compressed nitrogen gas, and then heated to 70° C. This resulted in an increase in the pressure to 492 psi (3.39 MPa). The contents were held at this condition for 5.5 hours, and was then cooled to 22° C. and held for another 70 minutes. The reaction was neutralized with triethanolamine (34.2 grams, 85% active in water) while at a pressure of 421 psi using the Teledyne syringe at a rate of 17.1 ml/min. The contents were mixed for 15 minutes and the vessel was depressurized to atmosphere. The resulting product was an emulsion with a mono-modal particle size distribution having a volume average particle diameter of 32.0 nanometers. The emulsion contained 1.5% octamethylcyclotetrasilane, 1.1% decamethylcylcopentasiloxane, and 0.36% dodecamethylcylcohexasiloxane, as measured by gas chromatography.

1. A process for producing a polysiloxane emulsion comprising the steps of:
I) combining;
a) an emulsifier,
b) a silicon monomer or oligomer having a solubility in water of at least 10 parts per billion (0.01 mg/L),
c) a polymerization catalyst,
and water to form a mixture,
II) reacting the mixture of step I) in a closed system having a pressure greater than 1 MPa to form a polysiloxane emulsion.

2. The process according to claim 1 where the mixture of step I) is an emulsion.

3. The process according to claim 1 where the pressure in step II) is greater than 2 MPa.

4. The process according to claim 1 where the emulsifier a) is an anionic, cationic, nonionic, zwitterionic surfactant or a mixture thereof.

5. The process according to claim 1 where the silicon monomer or oligomer is a cyclic siloxane containing three to six silicon atoms, or a mixture thereof, or a hydrolytic product thereof, each having a solubility in water of at least 10 ppb or 0.01 mg/L.

6. The process according to claim 5 where the silicon monomer or oligomer further contains one or more organosilane of the general formula RₐSi(OR′)₄₋ₐ where R are the same or different monovalent hydrocarbon or organofunctional substituted hydrocarbon groups having 1-18 carbon atoms, R′ are selected from the group consisting of the hydrogen atom, alkyl radicals containing 1 to 4 carbon atoms, CH₃C(O)—, CH₃CH₂C(O)—, HOCH₂CH₂—, CH₃OCH₂CH₂—, and C₂H₅OCH₂CH₂—, a is 0, 1, 2 or 3, or a hydrolytic product thereof, each having a solubility in water of at least 10 ppb or 0.01 mg/L.

7. The process according to claim 1 where the catalyst c) is a condensation catalyst.

8. The process according to claim 1 where the catalyst c) is also a surfactant.

9. A polysiloxane emulsion prepared by the process according to claim 1.

10. The polysiloxane emulsion of claim 9 wherein the polysiloxane has a octamethylcyclotetrasiloxane (D₄) and decamethylcyclopentasiloxane (D₅) content less than 10 wt % of the total polysiloxane in the emulsion.

11. The polysiloxane emulsion of claim 9 wherein the polysiloxane has a octamethylcyclotetrasiloxane (D₄) and decamethylcyclopentasiloxane (D₅) content less than 5 wt % of the total polysiloxane in the emulsion.
